(19) United States
(12) Patent Application Publication
(10) Pub. No.: US 2001/0029544 A1
(43) Pub. Date: Oct. 11, 2001

(54) System for increasing data packet transfer rate between a plurality of modems and the internet

(76) Inventor: Robert E. Cousins, Saratoga, CA (US)

Correspondence Address: LAW OFFICE OF THOMAS SCHNECK, P.O. BOX 2-E, SAN JOSE, CA, 95109-0005, US

(21) Appl. No.: 09/821,164

(22) Filed: Mar. 28, 2001

Related U.S. Application Data
(63) Continuation-in-part of application No. 09/535,028, filed on Mar. 24, 2000.

(51) Int. Cl. G06F 15/16

(52) U.S. Cl. 709/233; 709/217

(57) ABSTRACT

A system and a method for increasing the data packet transfer rate in a computer network environment and provide faster service to an Internet service provider's dial-in clients. This invention employs a connection optimization interface (COI) device that intermediates between a client and a server to optimize the data packet transfer rate and is located between a bank of modems and the Internet at an Internet service provider's facility. The COI device contains asymmetric TCP/IP stacks and related software to increase the throughput performance of a network. Data packets, sent by either a client or a server, can be accumulated in a buffer of the COI device until such data packets reach the efficient transmission unit. Alternatively, if a data packet is too large to be transmitted before a timeout occurs, the packet is buffered and segmented into smaller packets to meet the efficient transfer unit. Once a data packet that approximates the size of the efficient transmission unit has been formed, it can be transferred to the client or server. The COI device also maintains historical connection speed information and other transmission data for clients and servers, optimizing the data transfer rates and only transferring the data at a rate at which the receiver can accept the data. Excess data packets are stored in a buffer until they can be forwarded. The COI device can also transform the data packets through compression, encryption and format conversion.

### CROSS REFERENCE TO RELATED APPLICATION

This application is a continuation-in-part of pending application Ser. No. 09/535,028, filed Mar. 24, 2000.

### FIELD OF THE INVENTION

The present invention relates to data communications between a server (e.g. web server) and a client. In particular, the invention relates to the efficient delivery of data packets in a network environment where clients and servers communicate at different speeds and the provision of faster service to an Internet service provider's dial-in customers.

### BACKGROUND ART

In wide area computer network environments, particularly the Internet, clients and servers (e.g. web servers) are connected to each other at vastly different speeds. Typical dial-in connections for clients transfer data at about 2-14kB/second, while servers generally have highly optimized T1 or other direct connections to the Internet that result in data transfer rates exceeding 200kB/second. This client and server speed mismatch can result in several problems. Namely, when the server transmits data packets at a speed much higher than the client can receive it, the transmission means must buffer the data packets until they can be delivered to the client. Currently, the Internet does provide some buffer mechanisms, but it is not required to as it is primarily a transmission scheme. Therefore, data packets cannot be delivered in the time period negotiated between a client and a server, so the server times out and retransmits the data packets, further compounding the problem.

The transfer of data packets occurs in the TCP/IP Transport Layer. This layer provides the segmentation and reassembly of data from upper-layer application and uniting the data into a data stream. Certain protocols are followed, such as acknowledgments of delivery and retransmission of unacknowledged data, that insure that data reaches the proper destination intact. The built in redundancy and confirmations leads to extra data transfers that are often superfluous.

There are several patents that propose to solve this problem. U.S. Pat. No. 6,006,264 to Colby et al. describes a switch which can monitor content requests, and direct flow between a client and a server by sending the request to the best-fit server. This invention detects client server flows based on the arrival of SYN and/or GETs from the client. The switch evaluates the speed and quality of the connection and distributes the requests to the appropriate server. The invention also discloses using multiple web servers that are transparent to the client.

U.S. Pat. No. 5,598,410 to Stone describes a method and apparatus for accelerating packet processing by implementing a switch based preprocessor to determine the requirements of the data transmission. The preprocessor might also restructure the data unit by removing unnecessary components to meet an associated directive. The data packet is then sent to the processor, which completes the transmission of the data.

U.S. Pat. No. 5,852,717 to Bhide et al. describes performance optimizations for computer network utilizing HTTP. The performance optimization includes the creation of a local proxy server, which can buffer requests and commonly requested files. This improves efficiency by creating local copies, and reducing the need for the request to travel to the server. The patent also discloses using the proxy server to buffer client requests during the handshaking procedure, and forwarding the requests during the file request procedure, thereby reducing the number of transmissions between a client and a server.

U.S. Pat. No. 5,918,002 to Klemets et al. shows a transmission protocol for efficiently transmitting large data streams over the internet. This invention employs a buffer at the client for temporary storage of incoming data packets and a selective retransmission protocol. When applied to a multimedia streaming application, the client calculates the estimated time of arrival for a data packet, and if it estimates that the data packet will arrive after its usefulness, it is discarded. This frees up the server resources by transmitting only those data packets that would be useful to the client, rather than forcing the client to receive all of the data packets, regardless of their usefulness.

U.S. Pat. No. 5,519,699 to Ohsawa describes a method for reducing the transmission delay when data packets are transmitted between two routers. The invention discloses creating a buffer memory in each router to hold the data packets until the router can forward those data packets. The first router sends the data packet before it receives a return signal from the second router, the data packet is then stored in the second router's buffer until the router signals its availability for the data packet.

U.S. Pat. No. 6,003,082 to Gampper et al. shows a system whereby a server filters and caches data requests from clients and selectively transmits the request data based upon certain criterion. The server takes into account server status, user profile limitations, and characteristics of the transmission itself. If the criterion is not met, the server will cache the request until the data transmission can proceed, or abandon the request. This system allows the server to deliver data packets only to those clients that are able to receive it. Since requests that cannot be fulfilled are moved to a cache, these requests do not tax the resources of the server, and consequently speed up those transmissions that can be completed.

There is still a need for an invention that enables the efficient delivery of data packets in a wide area network environment where clients and servers communicate at different speeds. There is also a need to provide faster service to an Internet Service Provider's dial-in customers.

An object of the present invention is to increase the efficiency and speed of TCP/IP connections between a client and a server and to reduce the number of retransmissions that occur during communication between a client and a server.

A further object of the present invention is to ensure that data packets are filled to an efficient size before they are forwarded over a TCP/IP connection and to allocate only those network connections necessary to serve a client or a server depending on the data traffic.

An additional object of the present invention is to provide a connection optimization interface device, whether acting as a bridge or a router, which can efficiently increase the throughput performance of a TCP/IP connection between a client and a server.

An additional object of the present invention is to provide transformation (e.g. compression and/or encryption) of data packets between a client and a server.

An additional object of the present invention is to maintain persistent connections to the servers so as to reduce the server load and response time by reducing the overhead time required to set up new connections.

Another object of the invention is to provide much faster service to an Internet service provider's dial-in customers, i.e. ISDN speeds for dial-in customers and DSL speeds for ISDN customers.

Still another object of the invention is to reduce up-stream bandwidth requirements through caching connections.

### SUMMARY OF THE INVENTION

The present invention provides a connection optimization interface (COI) device having a system and a method for accelerating the movement of data packets between a server and a client by allocating connections appropriate to the speed of the receiving unit and optimally utilizing an efficient packet size for each server and each client. The client uses the COI as a proxy to the universe of available hosts. The COI creates a persistent connection as required to various hosts on behalf of the client. The operations of the COI, described in greater detail below, provide much faster service to an Internet service provider's (ISP) dial-in customers.

The COI device acts as a data packet buffer in a network environment, intermediating between a bank of modems and the Internet at an ISP's facility. The COI device holds a packet in a buffer until enough data can be accumulated and translated, allowing it to be forwarded at the efficient transmission unit (ETU). Various translations can be performed, including dynamic transformation (e.g. compression (e.g. GZIP)), encryption (e.g. secure socket layer RSA encryption) and format conversion (e.g. GIF to JPEG and GIF to incremental GIF), stripping of data such as comments, and management of messages of identification and authorization passed between client and server (e.g. cookies). As this COI device acts as either a bridge or a router between client and server, it intercepts and can buffer all of the data packets in either direction.

The COI device observes attributes of the connection and uses them to optimize the connection. The COI device also observes and remembers attributes of the client and serves to optimize the connection when a new connection is established. Therefore, packets can be forwarded at a speed and size appropriate for the client or server, with the remainder held in a buffer. This method prevents the overburdening of transmission resources by preventing excess data from being sent if the recipient is currently unable to receive the data. Also, this system reduces timeouts and retransmissions of the same data packets by buffering the data packets and forwarding them when appropriate.

### BRIEF DESCRIPTION OF THE DRAWINGS

FIG. 1 is a block diagram showing where the COI device is located in a computer network in accordance with the invention.

FIG. 2a is a block diagram showing how a client and server connect to a computer network in the absence of the COI device.

FIG. 2b is a block diagram showing how the client and server are connected to the COI.

FIG. 2c is a block diagram of the hardware and software components and computer network connections of the COI device.

FIG. 3 is a flowchart of an operational sequence for operating the COI device to accelerate the flow of data packets in a computer network environment in accordance with the invention.

### BEST MODE OF CARRYING OUT THE INVENTION

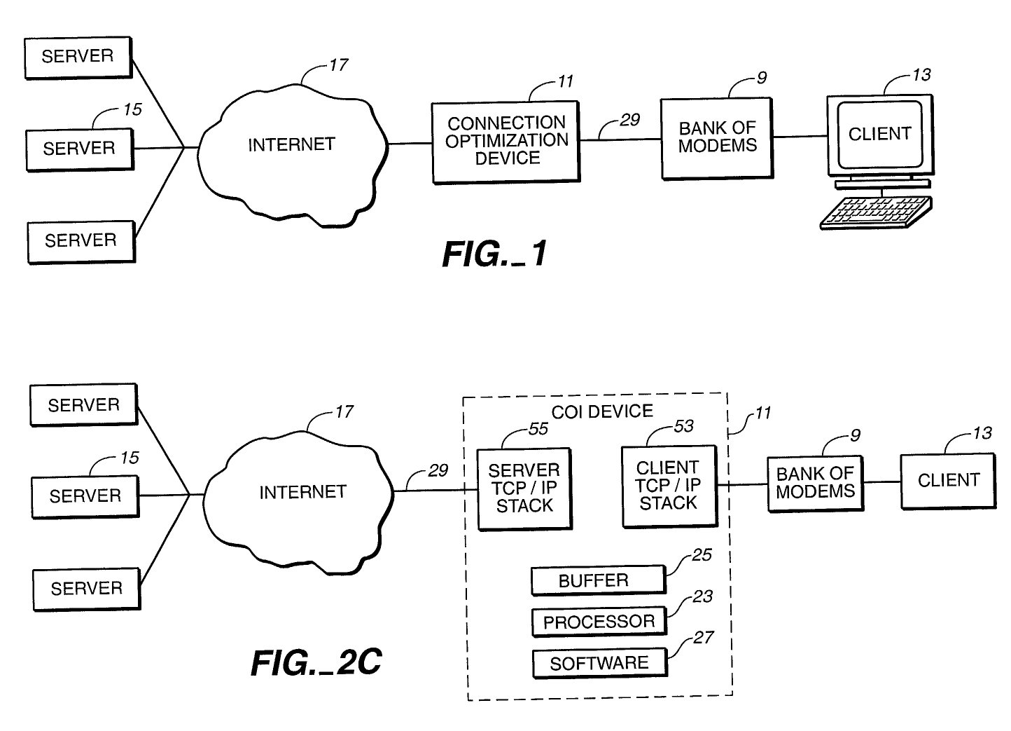

There are many inefficiencies in the TCP/IP Transport Layer, such as retransmissions, timeouts, and asymmetric data transfer rates, that occur in transmissions over a client and server computer network. The present invention addresses many of these problems. FIG. 1 shows the environment in which the COI device 11 operates. The COI device 11 intermediates between a client 13 and a server 15 in a network environment. In a client and server network environment, clients 13 and servers 15 communicate and transfer information through the transmission of data packets. The COI device 11 is connected to a plurality of clients 13 via a bank of modems 9 at an ISP facility. The COI device 11 is connected to a plurality of servers 15 via the Internet 17. Therefore, all of the data packets that are transferred between a client 13 and a server 15 are routed through the COI device 11.

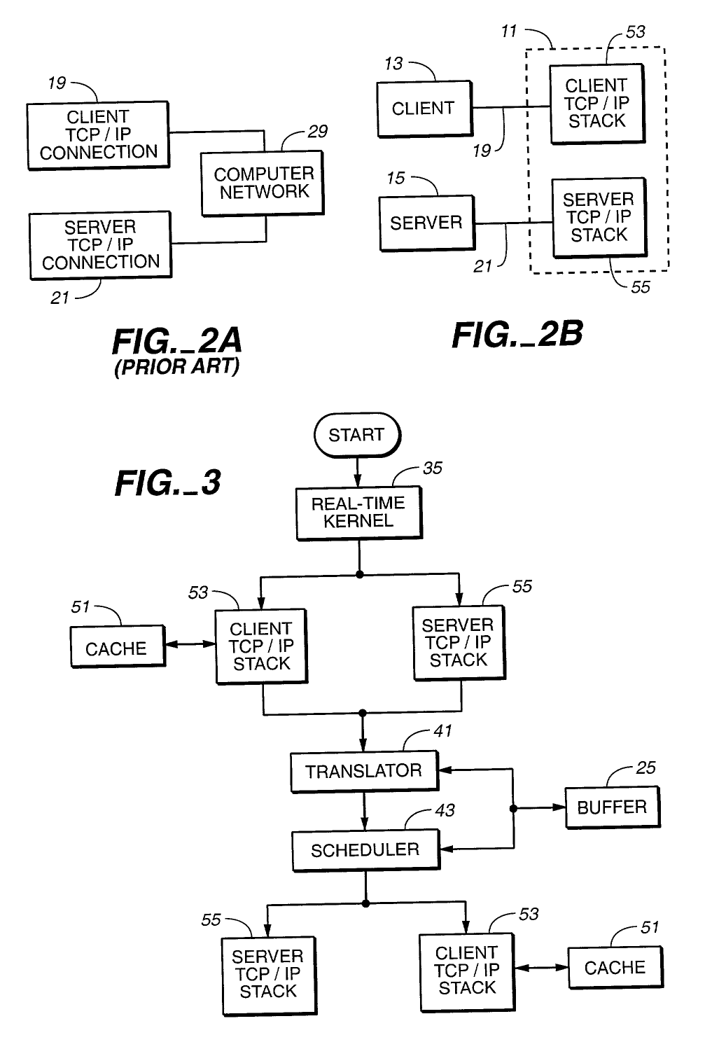

FIG. 2a shows how client TCP/IP connection 19 and server TCP/IP connection 21 connect the COI device 11 to a computer network 29 in the absence of the COI device 11.

FIG. 2b shows that COI device 11 contains the client TCP/IP stack 53 and the server TCP/IP stack 55. The client TCP/IP stack 53 establishes a persistent TCP/IP connection 19 to the computer network 29. In this implementation, a standard Ethernet network interface card and standard Ethernet cabling can make the client TCP/IP connection 19. The server TCP/IP stack 55 establishes a TCP/IP connection 21 to the computer network 29. As with the client TCP/IP connection 19, this connection can be made with a standard Ethernet network interface card and standard Ethernet cabling.

FIG. 2c illustrates some of the main components of the invention. The COI device 11 receives data packets from a client 13 over computer network 29 due to the TCP/IP connection established by the client TCP/IP stack 55. The server TCP/IP stack 55 establishes a connection between the COI device 11 and the modem bank 9 which is in turn connected to a plurality of servers 15.

The COI device 11 has a processor 23 for managing the processes of the system and a buffer 25 for storing data packets. The processor 23 can be a common micro-processor. The buffer 25 can be disk memory, random access memory or flash memory. In addition, the COI device 11 has software 27 for controlling the COI device 11 operation, performing translations on the data packets, transmitting the data packets, and scheduling the transmission of the data packets.

FIG. 3 shows the software application layer and the series of steps involved in the processing of a data packet by the COI device 11. The real time kernel 35 provides the operating environment and manages the software 27 contained in the COI device 11. The real time kernel 35 can multiplex threads onto one or more processors, allowing management of multiple processes simultaneously. The real time kernel 35 also manages the allocation and reallocation of memory in the COI device 11, providing such management in the stacks and threads themselves. The real time kernel 35 also provides synchronization and mutual exclusion functions, which allow threads to manage shared resources, await events, and otherwise communicate. Also necessary to the operation of the COI device 11 is a time management feature, which enables threads to interact, based upon time, which is necessary for timeouts and other time sensitive communications. The real time kernel 35 has additional management features that are similar to those known in the art.

The real time kernel 35 directs the incoming data packets to either the client TCP/IP stack 53 or the server TCP/IP stack 55, depending upon the origin of the data packet. The client TCP/IP stack 53 has several features that allow it to efficiently manage the client-side connection. First, the client TCP/IP stack 53 retains a cache 51 of client connection attributes on a per-IP address basis. These client connection attributes include the historic throughput performance between the client and the COI device, the latency of the connection, and the estimated efficient transmission unit. Moreover, the client TCP/IP stack 53 modifies the timeouts based upon the client connection attributes. Timeouts will be larger and more forgiving for slower data transfer rates.

The server TCP/IP stack 55 allows for maximum bandwidth allocation. The timeouts are unforgiving and tightly configured as this connection is generally very stable and reliable. The server TCP/IP stack 55 allows persistent connections, thereby reducing the time required to set up new connections.

Once the data packet has been processed by either the client TCP/IP stack 53 or the server TCP/IP stack 55, it is then forwarded to the translator 41. The translator 41 has several functions. First, it converts the contents of a HTML or XML request or reply into a new format. These translations can include the addition, modification or removal of messages of identification and authorization passed between a client and server (e.g. cookies), abstracting comments or other non-essential contents of a data packet, and transforming the data packet using a compression type algorithm in a manner that can be understood by the client 13 or server 15. Compression will take place only when the content is suitable for compression and if the client's web browser is capable of decompressing the packet. Further transformations can include encryption, such as secure socket layer RSA encryption, and format conversion, such as GIF to JPEG and GIF to incremental GIF. Also, the translation can include the combination of several data packets into a single data packet and the partitioning of a single data packet into several data packets.

In the prior art, when data is transferred between a client 13 and a server 15, packets are often partially filled but the packet nevertheless is designated as an efficient transmission unit (ETU) regardless of the amount of data in the packet. This is an inefficient allocation of resources. The present invention solves this problem by combining several data packets into one data packet that can still meet the maximum transmission unit (MTU). The data packets are stored in the buffer 25 until the can be combined with other data packets. The problem is that each partially filled data packet is sent when needed for a particular data request. The TCP/IP Transport Layer has a handshaking procedure that requires numerous small packets to be transmitted between the client and server to establish the connection and to insure the proper receipt of data. A variety of data packets travel back and forth, including synchronization (SYN) and acknowledgment (ACK) requests. The present invention buffers several data packets and reformats them into a size that more efficiently approaches the MTU. The buffer collects the data packets and uses the translation module to consolidate them.

Occasionally when data is transferred between server and client, the packet can be too large to be transmitted to the client before a timeout occurs. This is an inefficient allocation of resources because the timeout requires additional activity by the server and can require retransmission of the previously sent data. The present invention solves this problem by buffering the packet from the server at a speed that will prevent server timeout and segmenting the data packet into several small data packets as required for an efficient transfer unit for the client.

A compression translation, such as an RFC-compliant algorithm, allows the COI device 11 to compress dynamic content. Dynamic content is data that is requested by the client 13 and is created dynamically by the server 15. It is not a simple transfer of a static file, which can be compressed at any time, archived for storage, and delivered to a client 13 upon request. The process of compressing content can be invoked at any point during data packet transfer. When a data packet is transferred by the COI device 11 to either the server TCP/IP stack 55 or client TCP/IP stack 53, the compression algorithm compresses the data packet. Then, when the data packet is received by either the client 13 or server 15, a local compression algorithm decompresses the data packet. Use of a common compression algorithm enables the system to operate without any modification of the client 13 or server 15. No software will have to be installed or configured at the client 13, which would greatly increase the optimal use of the connection.

After the translator 41 has translated the data packet, it moves to the scheduler 43. If the data packet is destined for a server 15, the scheduler 43 matches the completed client requests with available server connections. The data packet is then passed to the server TCP/IP stack 53 for transmission to the server 15. If a data packet is destined for a client 13, the scheduler 43 will establish the appropriate connection with the client 13 and forward the data packet through the client TCP/IP stack 53 at a data transfer rate appropriate to the client connection attributes contained in the cache 51. As noted above, individual packets may be combined or segmented for optimal transmission efficiency. Excess data packets will be held in a queue in the buffer 25 until the scheduler 43 determines that the client 13 can accept them.

1. A system for accelerating the flow of data packets between a client who is a dial-in customer of an Internet service provider and a server in a communication network comprising:
(a) a connection optimization interface device located at said Internet service provider's facility intermediating between a bank of modems and the Internet, and
(b) connection means for connecting the connection optimization interface device between a plurality of clients and a plurality of servers with each client and server requesting and transmitting a plurality of data packets from each other.

2. The system of claim 1 wherein the connection optimization device includes software means for managing the connection optimization interface device operation.

3. The system of claim 1 wherein the connection optimization interface device includes buffer means for storing data from the data packets and connection information.

4. The system of claim 1 wherein the connection optimization interface device includes memory means for storing the software means.

5. The system of claim 1 wherein the connection optimization interface device includes processor means for operating said connection optimization interface device.

6. A system for accelerating the flow of data packets between a client who is a dial-in customer of an Internet service provider and a server in a communication network comprising:
(a) a connection optimization interface device located at said Internet service provider's facility intermediating between a bank of modems and the Internet, said device having:
(i) buffer means for storing data from the data packets and connection information;
(ii) software means for managing the connection optimization interface device operation;
(iii) memory means for storing the software means;
(iv) processor means for operating the connection optimization interface device; and
(b) connection means for connecting the connection optimization interface device between a plurality of clients and a plurality of servers with each client and server transmitting and requesting a plurality of data packets from each other.

7. The system of claim 6 wherein the software means includes means for managing the client TCP/IP connection.

8. The system of claim 6 wherein the software means includes means for managing the server TCP/IP connection.

9. The system of claim 6 wherein the software means includes means for scheduling the data packet transmissions against servers.

10. The system of claim 6 wherein the software means includes means for scheduling the data packet transmissions against clients.

11. The system of claim 6 wherein the software means includes means for translating the data packets, wherein the translating means includes means for reformatting the data packets by adding, modifying or removing cookies, and by removing comments or other non-essential contents of the data packets.

12. The system of claim 6 wherein the software means includes means for determining the contents of the data packet and forwarding the data packet if it is filled to the efficient transmission unit.

13. The system of claim 6 wherein the software means includes means for determining the contents of the data packet and holding the data packet in the buffer if it does not approximate the efficient transmission unit, accumulating a plurality of data packets in the buffer, restructuring the data packets to approximate the efficient transmission unit, then forwarding the data packet.

14. The system of claim 6 wherein the software means contains a transformation means whereby the data packet size may be dynamically compressed or encrypted prior to transmission, with the client having a software transformation means to dynamically transform the data packet by decompression or de-encryption upon arrival.

15. The system of claim 6 wherein the buffer means is random access memory.

16. The system of claim 6 wherein the buffer means is flash memory.

17. The system of claim 6 wherein the buffer means is a disk memory.

18. The system of claim 6 wherein for each client connected to the device the software means further includes means for collecting data packet transfer rates between the device and the client, associating such rates with the client data packet header information, retaining the transfer rates in the buffer means, determining the average data transfer speed for data packets, forwarding the data packets at a rate approximate to the data transfer rate, queuing excess data packets in the buffer means.

19. The system of claim 6 wherein for each server connected to the device the software means further includes means for collecting data packet transfer rates between the connection optimization interface device and the server, associating such rates with the server data packet header information, retaining the transfer rates in the buffer means, determining the average data transfer speed for data packets, forwarding the data packets at a rate approximate to the data transfer rate, and queuing excess data packets in the buffer means.

20. The system of claim 6 wherein for each server connected to the connection optimization interface device the software means includes means for monitoring the connection means to determine an average connection speed between the server and the connection optimization interface device.

21. The system of claim 6 wherein for each client connected to the connection optimization interface device the software means includes means for monitoring the connection means to determine an average connection speed between the client and the connection optimization interface device and associating the resulting average connection speed information with the data packets.
